(19) United States
(12) Patent Application Publication
(10) Pub. No.: US 2007/0292751 A1
(43) Pub. Date: Dec. 20, 2007

(54) Battery Apparatus with Heat Absorbing Body

(76) Inventors: Jing-Yih Cherng, Tao-Yuan (TW); Te-Chuan Lai, Tao-Yuan (TW); Yen-Ling Chang, Tao-Yuan (TW)

Correspondence Address: HDSL, 4331 STEVENS BATTLE LANE, FAIRFAX, VA, 22033, US

(21) Appl. No.: 11/424,288

(22) Filed: Jun. 15, 2006

(51) Int. Cl. H01M 10/50; H01M 2/08

(52) U.S. Cl. 429/120; 429/62; 429/185

(57) ABSTRACT

A battery apparatus with a heat absorbing body includes a casing, a cell and a heat absorbing body. The casing includes a containing space, an anode and a cathode disposed at the exterior of the casing, and a cell and a heat absorbing body installed in the containing space. The cell includes an anode handle and a cathode handle connected to the anode and cathode respectively. The heat absorbing body is attached onto a surface of the cell and includes an upper soft film and a lower soft film sealed with the upper soft film, and a phase change material is filled between the upper and lower soft films, such that the phase change material can absorb or release large amounts of heat in a phase change process to maintain the cell operated at a lower and more stable operating temperature and extend the life of the battery apparatus.

### BACKGROUND OF THE INVENTION

1. Field of the Invention

The present invention relates to a battery apparatus with a heat absorbing body, and more particularly to a battery apparatus that installs and attaches a heat absorbing body between battery cells.

2. Description of Prior Art

As the development of science and technology advances, a plurality of cells are connected in series or in parallel to form a battery apparatus for supplying power for various different appliances. Since the battery apparatus has a low pollution that can comply with the environmental protection requirements and provide a high power current output, the battery apparatuses are used extensively in many electric appliances and equipments including electric tools, electric motorcycles and electric cars. However, such electric appliances and equipments require a power recharge function. Since the output of the electric power is in form of a short-duration high current, each cell results in a high temperature easily and it is an important issue for manufacturers to find a way to solve the heat dissipation problem of the cells.

Traditional battery apparatuses generally include a metal pad handle between cells, and the cell together with the metal pad handle are installed and connected into the casing, so that the heat produced by the operation of each cell can be dissipated by conducting and carrying away the heat from the metal pad handle to the outside.

Although traditional battery apparatuses may come with slight heat conducting and dissipating functions, their actual applications still have the following existing problems. Since the cells must be stacked with each other to achieve the miniaturization or compact requirements, therefore the heat dissipating area of the battery apparatuses will be reduced greatly and the heat conducting and dissipating efficiencies will become poor. Further, the power supply of the battery apparatus involves a short-duration high current output, and the quantity of produced heat is directly proportional to the square of the passing current. If a high current is passed, the speed of producing heat will be much larger than the speed of dissipating heat by natural air convection, and thus each cell will be at a high temperature state. Further, the electric appliances and equipments must have the power recharge function, and thus the temperature of each cell will be increased during the recharge process. The high-temperature environment and the long-hour use greatly reduce the life of the electric appliances and equipments. If there is no effective heat conducting and dissipating methods, it may even cause risks to the safety of using the electric appliances and equipments if the temperature of each cell reaches 60° C. or above.

In view of the foregoing shortcomings of the prior art, the inventor of the present invention based on years of experience in the related industry to conduct experiments and modifications, and finally designed a feasible solution to overcome the shortcomings of the prior art.

### SUMMARY OF THE INVENTION

Therefore, the present invention is to overcome the shortcomings of the prior art by providing a battery apparatus with a heat absorbing body that installs and attaches a heat absorbing body onto the exterior of cells, so that a phase change material in the heat absorbing body can absorb the heat released by the cells to maintain the operations at a permitted operating temperature and extending the life of use of the battery apparatus.

The present invention provides a battery apparatus with a heat absorbing body that comprises a casing, a cell and a heat absorbing body, wherein the casing includes a hollow containing space disposed inside the casing, an anode and a cathode disposed outside the casing, and a cell and a heat absorbing body disposed in the containing space. The cell includes an anode handle and a cathode handle, and the anode handle and the cathode handle are connected to the anode and the cathode of the casing respectively. An end of the heat absorbing body is attached onto an end surface of the cell and has an upper soft film, a lower soft film sealed with the upper soft film, and a phase change material disposed between the upper and lower soft films.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is an exploded view of a battery apparatus of the present invention;

FIG. 2 is a cross-sectional view of a battery apparatus of the present invention;

FIG. 3 is a cross-sectional view of a heat absorbing body according to a first preferred embodiment of the present invention;

FIG. 4 is a cross-sectional view of a heat absorbing body according to a second preferred embodiment of the present invention;

FIG. 5 is a top view of a heat absorbing body according to a third preferred embodiment of the present invention;

FIG. 6 is a cross-sectional view of a heat absorbing body according to a third preferred embodiment of the present invention; and

FIG. 7 is a cross-sectional view of a battery apparatus according to another preferred embodiment of the present invention.

### DETAILED DESCRIPTION OF THE INVENTION

The technical characteristics, features and advantages of the present invention will become apparent in the following detailed description of the preferred embodiments with reference to the accompanying drawings, and the drawings are provided for reference and illustration and not intended for limiting the scope of the present invention.

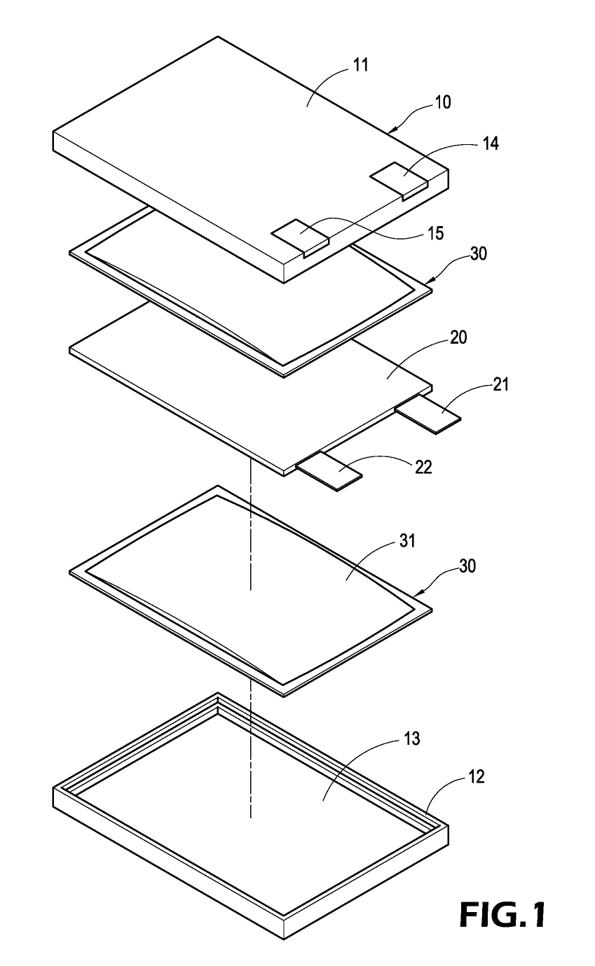

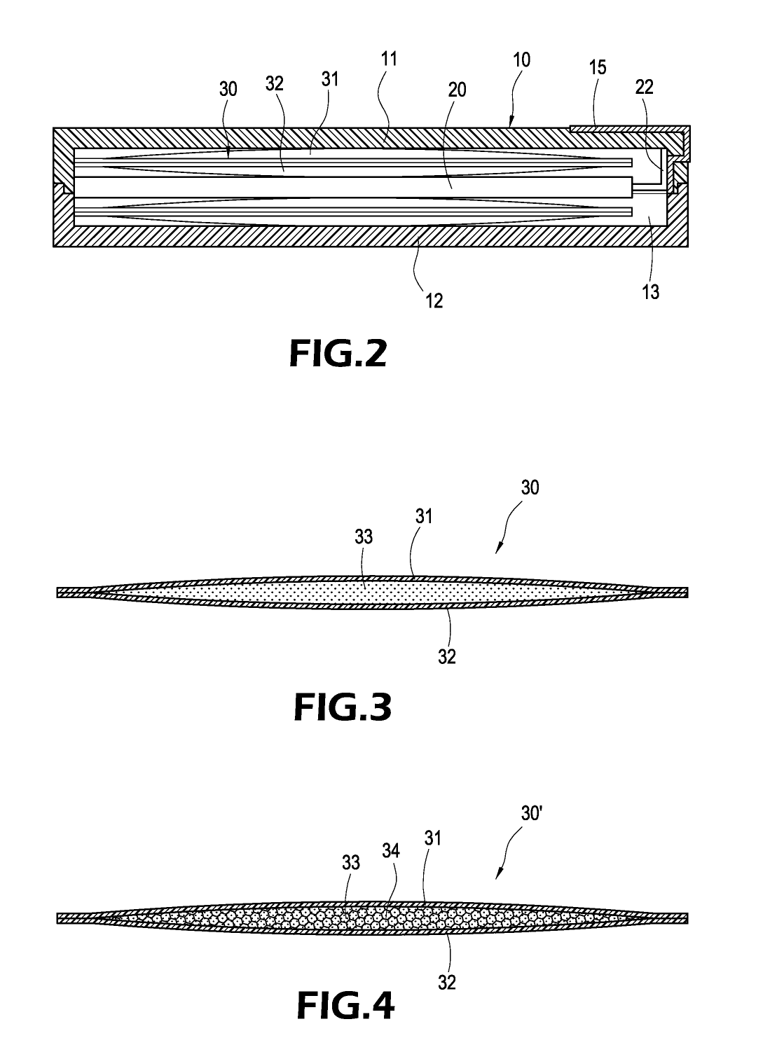

Referring to FIGS. 1 to 3 for the exploded view and the cross-sectional view of a battery apparatus of the present invention and the cross-sectional view of a heat absorbing body according to a first preferred embodiment of the present invention respectively, the invention provides a battery apparatus with a heat absorbing body, and the preferred embodiment comprises a casing 10, a cell 20 and two heat absorbing bodies 30.

The casing 10 includes an upper casing panel 11 and a lower casing panel 12 connected to the bottom of the upper casing panel 11, each casing panel 11, 12 could be made of a plastic material, a hollow containing space 13 is formed between the upper casing panel 11 and the lower casing panel 12, and the exterior of the upper casing panel 11 includes an anode 14 and a cathode 15.

The cell 20 is installed in the containing space 13 of the casing 10 and could be a secondary battery such as a lithium-ion battery or a polymer lithium battery. A lateral side of the cell 20 has an anode handle 21 and a cathode handle 22, and the anode handle 21 is electrically coupled to the anode 14 of the casing 10, and the cathode handle 22 is electrically coupled to the cathode 15 of the casing 10.

One or more heat absorbing bodies 30 could be installed in the containing space 13 of the casing 10. This preferred embodiment includes two heat absorbing bodies 30. An end surface of each heat absorbing body 30 is attached onto the corresponding surface of the cell 20, and the heat absorbing body 30 includes an upper soft film 31 and a lower soft film 32 sealed and coupled to the upper soft film 31. The upper soft film 31 and the lower soft film 32 could be made of metal foils (such as aluminum foils and nickel foils), a phase change material 33 is filled between the upper soft film 31 and the lower soft film 32, and the phase change material 33 could be sodium silicate, sodium borate, sodium sulfate, paraffin or their mixtures. Further, the sodium sulfate mixture is composed of water, sodium sulfate, sodium borate, bentonite clay powder and attapulgite clay, and the mixture is in a thick sticky form at room temperature (below 32° C.) for providing the best water absorbing effect and shortening the crystallization time.

The anode and cathode of the casing 10 can be connected to an electric appliance or equipment (not shown in the figure) for supplying electric power to the electric appliance or equipment. After the electric appliance or equipment is turned on, each cell 20 will output electric currents continuously, thus each cell 20 will produce high heat, and such heat will be conducted to the heat absorbing body 30 to heat up the heat absorbing body 30. The phase change material 33 installed in the heat absorbing body 30 absorbs a large amount of heat during the process of converting a solid phase into a liquid phase or a liquid phase into a gas phase, so that each cell 20 can be operated continuously at a lower operating temperature, so as to achieve the effect of extending the life of the battery apparatus.

Referring to FIG. 4 for the cross-sectional view of a heat absorbing body according to a second preferred embodiment of the present invention, the heat absorbing body could be in form as illustrated in the foregoing preferred embodiment or a porous tissue 34 disposed between the upper soft film 31 and the lower soft film 32, such that the phase change material 33 can be evenly distributed in the heat absorbing body 30′, and the porous tissue 34 could be a sponge or an unwoven cloth.

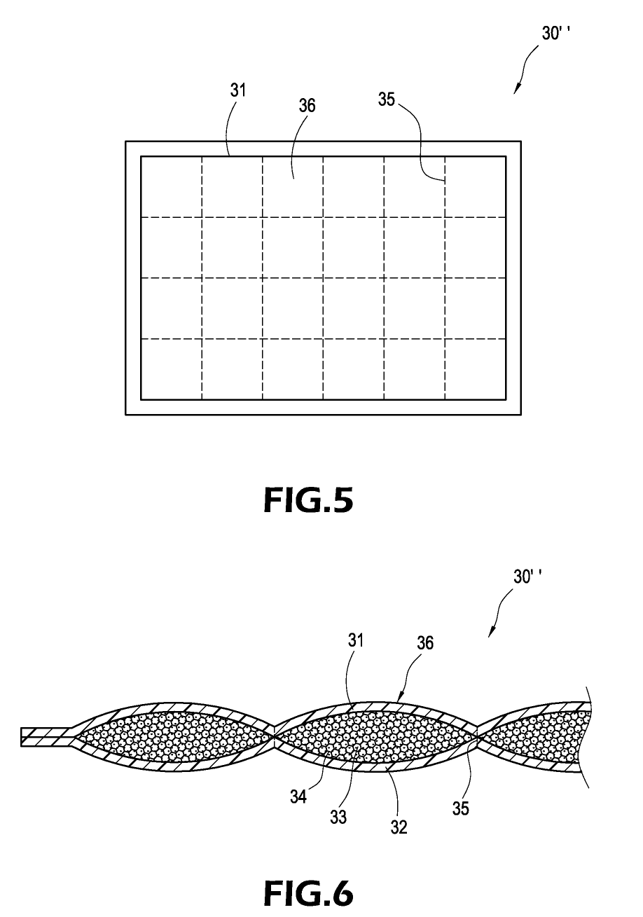

Refer to FIGS. 5 and 6 for the top view and the cross-sectional view of a heat absorbing body according to a third preferred embodiment of the present invention. To avoid the phase change material 33 of the heat absorbing body 30″ from being affected by gravitation or the occurrence of aggregation or precipitation of the phase change material 33 after the phase change material 33 is heated or melted, the openings of the upper soft film 31 and the lower soft film 32 are sealed after the phase change material 33 and the porous tissue 34 are installed between the upper soft film 31 and the lower soft film 32, and then the upper soft film 31 and the lower soft film 32 are thermally pressed by a hot-press machine to form partition bars 35 along the lengthwise, transversal and diagonal directions or in other different irregular patterns between the upper soft film 31 and the lower soft film 32 and separate several non-interconnected blocks 36 on the heat absorbing body 30″, so that the phase change material 33 in each block 36 cannot move freely.

If a hole occurs at a portion of the upper soft film 31 or the lower soft film 32 of each block 36, the whole phase change material 33 will not be lost, so as to prevent overheating or damaging the cell 20. Further, the installation of the partition bars 35 can enhance the effect of holding the porous tissue 34.

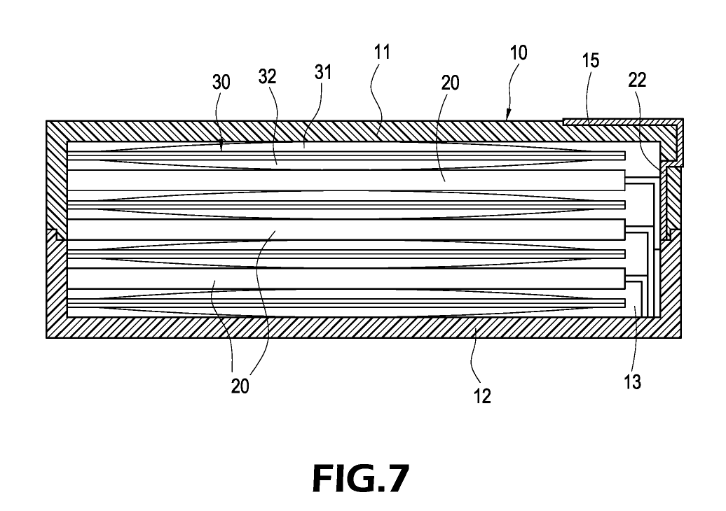

Refer to FIG. 7 for the cross-sectional view of a battery apparatus according to another preferred embodiment of the present invention. To meet the current requirements of various different products, a plurality of cells 20 and a plurality of heat absorbing bodies 30 can be installed in the containing space 13 of the casing 10. In the heat absorbing body 30 disposed between two cells 20, the upper soft film 31 and the lower soft film 32 are attached separately onto the end surfaces of each cell 20 for absorbing the heat produced by the operation of each cell 20.

In addition of the aforementioned advantages, the battery apparatus with a heat absorbing body of the present invention will not cause corrosion or electric conduction problems to the cells 20, since the phase change material 33 is sealed between the upper soft film 31 and the lower soft film 32 and selectively installed at a high-heat area (such as the central position) according to the actual heat dissipating requirements of the battery apparatus, so as to achieve the best heat dissipating performance.

In summation of the description above, the battery apparatus with a heat absorbing body of the invention definitely achieves the foregoing objectives and complies with the patent application requirements.

The present invention are illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A battery apparatus with a heat absorbing body, comprising:
a casing, having a hollow containing space disposed inside the casing and an anode and a cathode disposed outside the casing;
a cell, installed in the containing space and having an anode handle and a cathode handle coupled to the anode and the cathode respectively; and
a heat absorbing body, installed in the containing space and having an end attached onto an end surface of the cell, including an upper soft film and a lower soft film sealed with the upper soft film, and a phase change material being filled between the upper soft film and the lower soft film for absorbing or releasing heat produced or required by the cell.

2. The battery apparatus with a heat absorbing body of claim 1, wherein the casing includes an upper casing panel and a lower casing panel coupled to a side of the upper casing panel, and the containing space is formed between the upper casing panel and the lower casing panel.

3. The battery apparatus with a heat absorbing body of claim 2, wherein the upper casing panel includes the anode and the cathode disposed at an exterior of the upper casing panel.

4. The battery apparatus with a heat absorbing body of claim 1, wherein the cell is one selected from a lithium-ion battery and a polymer lithium battery.

5. The battery apparatus with a heat absorbing body of claim 1, wherein the upper soft film and the lower soft film include a plurality of partition bars disposed therebetween and a plurality of non-interconnected blocks divided by the heat absorbing body.

6. The battery apparatus with a heat absorbing body of claim 1, wherein the phase change material is one selected from sodium silicate, sodium borate, sodium sulfate, paraffin, and mixtures thereof.

7. The battery apparatus with a heat absorbing body of claim 6, wherein the sodium sulfate mixture is composed of water, sodium sulfate, bentonite clay powder and attapulgite clay.

8. The battery apparatus with a heat absorbing body of claim 1, wherein the upper soft film and the lower soft film are metal foils.

9. The battery apparatus with a heat absorbing body of claim 1, wherein the heat absorbing body further includes a porous tissue sealed and fixed inside the upper soft film and the lower soft film.

10. The battery apparatus with a heat absorbing body of claim 9, wherein the porous tissue is one selected from a sponge and an unwoven cloth.
